(19) United States
(12) Patent Application Publication
(10) Pub. No.: US 2023/0149761 A1
(43) Pub. Date: May 18, 2023

(54) NOISE REDUCTION ASSEMBLY FOR MOTOR-DRIVEN EXERCISE DEVICE

(71) Applicant: Arena Innovation Corp., New York, NY (US)

(72) Inventors: Krisna BHARGAVA, San Francisco, CA (US); Nicholas BUCKLES, Santa Monica, CA (US)

(21) Appl. No.: 17/985,645

(22) Filed: Nov. 11, 2022

Related U.S. Application Data
(60) Provisional application No. 63/278,813, filed on Nov. 12, 2021.

(51) Int. Cl. A63B 21/005; F16F 15/12

(52) U.S. Cl. CPC A63B 21/0058; F16F 15/12

(57) ABSTRACT

An exercise device includes a housing and an internal frame disposed within the housing. The exercise device includes a dampening system that includes a dampening block coupled to a web of the internal frame disposed within the housing. The exercise device includes a motor having a motor casing and a shaft with the shaft supported and rotationally fixed by the dampening block. The exercise device may include a cable pulley coupled to the motor casing such that, when the motor is actuated, each of the motor casing and the cable pulley rotate to extend the cable from or retract the cable into the housing. Among other things, the dampening block attenuates vibrations produced by the motor during actuation, improving performance of the exercise device and enhancing user experience.

### CROSS-REFERENCE TO RELATED APPLICATION

This application is related to and claims priority under 35 U.S.C. § 119(e) from U.S. Patent Application No. 63/278,813, filed Nov. 12, 2021, titled “Noise Reduction Assembly for Moto-Driven Exercise Device”, the entire contents of which are incorporated herein by reference for all purposes.

### TECHNICAL FIELD

Aspects of the present invention are directed to exercise devices and, in particular, to noise and vibration reduction in motor-driven exercise devices.

### BACKGROUND

The benefit of regular exercise is undisputed. Nonetheless, beginning and maintaining a successful exercise regimen is a challenge for many individuals for a variety of reasons. For example, simply finding the time to begin an exercise program is a challenge. Finding an exercise, or more preferably exercises, suitable for an individual and his or her personal fitness goals is a further complication given that many people have insufficient knowledge as to different types of exercises, the benefits of different exercise, and how to perform those exercises. With time constraints and a lack of knowledge, users may also fail to properly track and analyze performance and progress, leading to lackluster development and impacting motivation to maintain an exercise program. As a result, there is an ongoing need to develop efficient exercise devices that provide ways to easily perform exercises correctly with optimal resistance to maximize results in minimal time.

While exercising at home may increase the likelihood of a person staying within an exercise regime, professional grade exercise equipment is often large and cumbersome and is often designed for only a small set of exercises. While exercise devices with form factors suitable for home use exist, such equipment often lacks the robustness of professional grade equipment, negatively impacting the efficiency of such devices and introducing vibrations and instability that significantly impact user experience and, in certain cases, the effectiveness and safety of exercises performed using such devices.

It is with these observations in mind, among others, that aspects of the present disclosure were developed.

### SUMMARY

A first aspect of this disclosure is directed to an exercise device including a housing having a top portion and a bottom portion and an internal frame disposed within the housing. The internal frame includes a web extending between the top portion and the bottom portion. The exercise device further includes a dampening block coupled to the web and a motor including a motor casing and a shaft. The shaft is supported by the dampening block and rotationally fixed by the dampening block. The exercise device further includes a cable pulley coupled to the motor casing such that, when the motor is actuated, each of the motor casing and the cable pulley rotate.

In certain implementations the dampening block includes a shaft coupling assembly. In such implementations, the shaft extends into the shaft coupling assembly and is rotationally fixed by the shaft coupling assembly and the exercise device further includes a dampening pad disposed between the shaft coupling assembly and the web.

In other implementations the dampening block includes a shaft coupling assembly. In such implementations, the shaft coupling assembly includes a block defining a channel and the shaft extends along the channel. The shaft coupling assembly further includes a cover plate abutting the block and covering the channel. The shaft includes a flat within which a portion of the cover plate is disposed to rotationally fix the shaft. The exercise device further includes a dampening pad disposed between the shaft coupling assembly and the web.

In other implementations the techniques described herein relate to an exercise device further including a bracket coupled to each of the dampening block and the internal frame, wherein the dampening block includes a shaft coupling assembly and a dampening pad disposed between the bracket and the shaft coupling assembly.

In other implementations the exercise device further includes a bracket and the internal frame further includes a transverse member offset from the web. In such implementations, the bracket is coupled to each of the dampening block and the transverse member.

In other implementations the exercise device further includes a bracket and the internal frame further includes a transverse member offset from the web and disposed adjacent the top portion. In such implementations, the bracket is coupled to each of the dampening block and the transverse member.

In other implementations the exercise device further includes an encoder supported by the web. The cable pulley is coupled to the encoder by a flexible shaft coupling and the encoder is configured to measure rotation of the cable pulley.

In other implementations the motor is a brushless direct current (BLDC) motor and the exercise device further includes a motor controller to actuate the motor using trapezoidal commutation.

In other implementations, the web is coupled to each of the top portion and the bottom portion.

Another aspect of the present disclosure is directed to an exercise device including a housing and a motor including a motor casing and a shaft. The shaft is rotationally fixed within the housing by a dampened connection and supports the motor casing within the housing. The exercise device further includes a cable pulley extending from the motor casing such that, when the motor is actuated, each of the motor casing and the cable pulley rotate.

In certain implementations the exercise device further includes an internal frame disposed within the housing and the dampened connection includes a dampening block coupled to the internal frame.

In other implementations the exercise device further includes an internal frame disposed within the housing and the internal frame includes a web extending between a top portion of the housing and a bottom portion of the housing. In such implementations the dampened connection includes a dampening block coupled to the web.

In other implementations the exercise device further includes an internal frame disposed within the housing and the dampened connection includes a dampening block coupled to the internal frame and a bracket coupled to and extending between each of the dampening block and the internal frame.

In other implementations the exercise device further includes an internal frame disposed within the housing and the dampened connection includes a dampening block coupled to a transverse web of the internal frame. The dampened connection further includes a bracket coupled to and extending between each of the dampening block and a transverse member of the internal frame offset from the transverse web.

In other implementations the exercise device further includes an internal frame disposed within the housing and the internal frame includes a web extending between a top portion and a bottom portion of the housing with the dampened connection between the shaft and the web. In such implementations the exercise device further includes an encoder supported by the web and rotationally coupled to the cable pulley to measure rotation of the cable pulley.

In other implementations the motor is a brushless direct current (BLDC) motor and the exercise device further includes a controller to actuate the motor using trapezoidal commutation.

Yet another aspect of the present disclosure is directed to an exercise device including a housing having a top portion and a bottom portion and an internal frame disposed within the housing. The internal frame includes a web extending between the top portion and the bottom portion and a support member offset from the web. The exercise device further includes a dampening block coupled to the web, a bracket coupled to and extending between each of the dampening block and the support member, and a motor including a motor casing and a shaft with the shaft is rotationally fixed by the dampening block.

In certain implementations the motor is a brushless direct current (BLDC) motor and the exercise device further includes a motor controller to actuate the motor using trapezoidal commutation.

In other implementations the dampening block includes a block defining a channel and the shaft extends through the channel. The dampening block further includes a cover plate abutting the block with the cover plate rotationally fixing the shaft, a first dampening pad disposed between and abutting each of the cover plate and the web, and a second dampening pad disposed between and abutting each of the cover plate and the bracket.

In other implementations the top portion includes an aperture and the exercise device further includes a cable pulley coupled to the motor casing, a cable coupled to the cable pulley, and a fairing disposed in the aperture. In such implementations, the cable is routed through the aperture and selectively retractable through the aperture by actuating the motor.

### BRIEF DESCRIPTION OF THE DRAWINGS

The referenced figures of the drawings illustrate various example embodiments of this disclosure. The embodiments and figures described in this disclosure are to be considered illustrative rather than limiting.

FIG. 1 is a first isometric view of an exercise device according to the present disclosure.

FIG. 2 is a second isometric view of the exercise device of FIG. 1 with a housing partially removed to illustrate internal components of the exercise device.

FIG. 3 is a diagram of an operating environment including the exercise device of FIG. 1 in which functions of the exercise device are supported by a user computing device and a remote fitness platform.

FIG. 4 is an elevation view of a web assembly of the exercise device of FIG. 1.

FIG. 5 is a first isometric view of the web assembly of FIG. 4.

FIG. 6 is a second isometric view of the web assembly of FIG. 4.

FIG. 7 is a partially exploded view of the web assembly of FIG. 4.

FIG. 8 is an exploded view of a dampening block of the web assembly of FIG. 4.

FIG. 9 is a partial cross-sectional view of the dampening block of FIG. 8 as assembled in the web assembly of FIG. 4.

FIG. 10 is a partial isometric view of internal components of the exercise device of FIG. 1 illustrating an example placement of a support bracket coupled to the dampening block.

FIG. 11 is a partial isometric view of the web assembly of FIG. 4 illustrating an encoder and encoder coupling.

### DETAILED DESCRIPTION

Aspects of this disclosure include exercise devices for use in performing various resistance-based exercises. The exercise devices include a housing having a top portion through which a motor-driven cable extends. In certain implementations, the housing may have a form factor similar to that of a fitness step/step platform, a plyometric box, or other similar fitness equipment; however, and more generally, the housing may have any suitable prismatic shape that facilitates the various use cases discussed in this disclosure. A user can equip the end of the cable with a grip, collar, belt, or similar component to facilitate performance of different exercises. During operation, the motor supplies resistance by counteracting extension of the cable by the user and/or controllably retracting the cable against the user. The exercise device may include or be in communication with computing elements configured to control the motor, measure user performance, monitor system behaviors, and perform other similar functions.

The motor replaces weights, bands, and other resistance elements found in conventional exercise equipment. The motor may provide a controllable resistance force, which may be a constant resistance force and retraction rate. However, the motor can also be actively controlled to provide greater variety and flexibility as compared to conventional resistance sources (e.g., weights, bands, etc.). For example, and among other things, the exercise device may control the motor to supply resistance that automatically varies over a given range of motion (e.g., applying a different resistance during the concentric versus eccentric phase of an exercise or varying in response to some user feedback parameter such as extraction rate) or provides a constant resistance that eliminates inertial effects common with conventional resistance elements.

The exercise device may include or be communicably coupled to various devices for controlling the exercise device and providing feedback to a user. For example, the exercise device may connect to and communicate with a computing device, such as a smartphone, tablet, laptop, smart television, etc., to enable the user to select a workout and/or exercise, adjust exercise parameters (e.g., a range of motion of the exercise, a speed of the exercise, a load, or any other similar parameter), view historical performance data, and the like. In certain implementations, such computing devices may also facilitate streaming of video or other multimedia content (e.g., classes) to guide a user's exercise or to facilitate participation in streaming or real-time interactive classes and competitions. In still other implementations, the exercise platform may be used in conjunction with a gaming platform or other computing device capable of running games or similar interactive software. The exercise device may also receive control instructions from such computing devices.

Exercise devices of this disclosure may also connect to and communicate with each other or to other computing devices over a network, which may include the Internet, local networks, and combinations thereof. In one implementation, a cloud-based platform may interact with exercise devices of this disclosure and associated user computing devices (e.g., a user's smartphone) to distribute resistance profiles (which may include control instructions) for exercises, store and update user information including information representative of a user performing an exercise, and present tracking information to users and personnel such as gym facility managers, personal trainers, physiotherapists, and others who may be working with a user. The cloud-based computing platform further enables the generation, updating, and storage of content for use with the exercise device including, but not limited to, resistance profiles, workout plans, multimedia content, and the like.

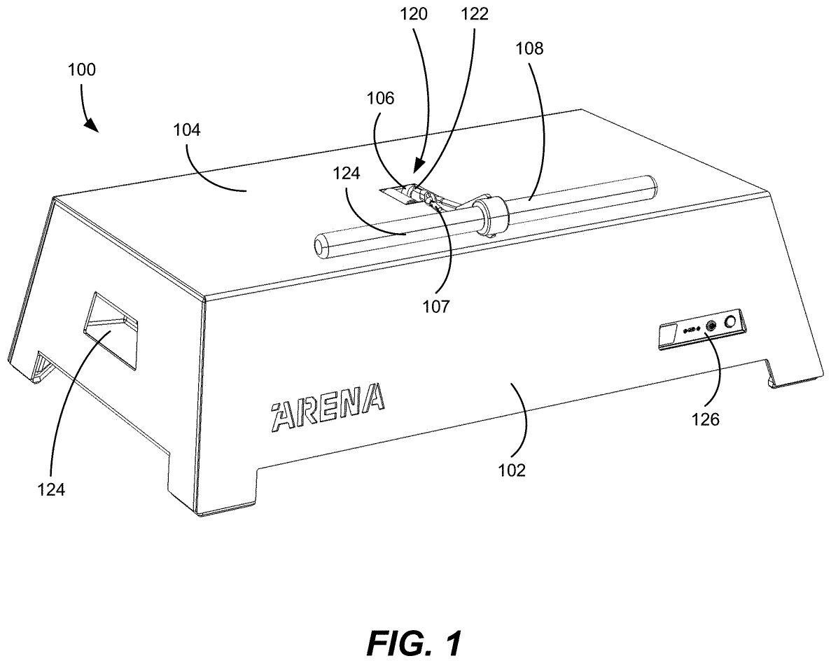

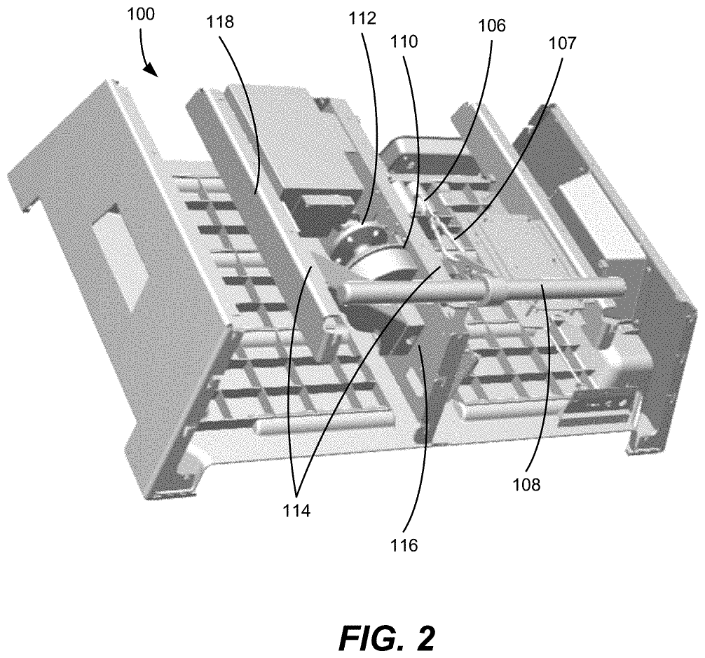

FIG. 1 is an isometric view of an exercise platform 100 according to one implementation of the present disclosure. FIG. 2 is an isometric view of exercise platform 100 with a housing 102 and other external components removed to illustrate various internal components of the exercise platform 100. Referring to FIG. 1, exercise platform 100 includes a housing 102 having a top portion 104 through which a cable 106 passes. In certain implementations, top portion 104 includes an aperture 120 within which a fairing 122 or similar guide element is disposed to permit multi-directional retraction and extension of cable 106. As shown, cable 106 may end in a handle 108; however, in other implementations, cable 106 ends in a strap, grip, belt, rope loop, or similar component to facilitate performance of different exercises. More generally, the cable may be coupled with any suitable attachment to facilitate various possible exercises. Handle 108 may be permanently fixed to cable 106 or may be removable such that handle 108 may be swapped with one or more alternative attachments to facilitate different exercises. For example, as shown in FIG. 1, handle 108 couples to cable 106 by a carabiner 107. Carabiner 107 is just one example of a structure for easily coupling handle 108 to cable 106 and this disclosure contemplates that any suitable coupling mechanism may be used to join handle 108 to cable 106. During performance of an exercise, a user extends cable 106 and/or resists retraction of cable 106 with resistance provided by a motor 110 (shown in FIG. 2) disposed within housing 102 and coupled to cable 106, e.g., by a cable pulley 112 (also shown in FIG. 2) coaxially mounted to motor 110, and about which the cable is spooled and unspooled during operation. In certain implementations, cable pulley 112 may be a separate component coupled to a rotating component (e.g., an axle or rotating casing) of motor 110. Alternatively, cable pulley 112 may be integrally formed with the rotating component of motor 110.

Exercise platform 100 may include a control system (including, e.g., a motor controller, a motor drive, a microprocessor, and/or other related components) for actuating/controlling motor 110 and the resistance provided by motor 110. Exercise platform 100 may further include various sensors for providing feedback to the control system to facilitate control of motor 110. For example, in certain implementations, exercise platform 100 may include one or more of a current sensor, a position sensor (e.g., an encoder), an accelerometer, or another sensor for measuring parameters related to motor activity and which can be used in the control and operation of motor 110. In certain implementations, force sensors (e.g., load cells, strain gauges, etc.) incorporated into exercise platform 100 may also supply feedback for controlling motor 110, assessing user performance, energizing the exercise device, providing information to the exercise device or other systems, and other similar functions.

Motor 110 and the associated motor control components may provide a variety of different resistance profiles depending on the exercise being performed, settings provided by the user, a workout plan of the user, and the like. In one mode of operation, motor 110 may provide constant resistance over a complete range of motion for an exercise. As another example, motor 110 may provide a first resistance during a first phase of an exercise (e.g., a concentric phase of the exercise) and a second, different, resistance during a second phase of the exercise (e.g., an eccentric phase of the exercise). As yet another example, motor 110 may vary resistance over any or all phases of an exercise. In at least certain implementations, the system may provide controls (e.g., through a user interface provided on a smart phone or tablet) to set a starting point for an exercise, which may correspond to an amount of retraction (unspooling) of the cable above which the resistance force is applied and below which a nominal retraction force is applied.

By way of example, a user of exercise platform 100 may perform a squat motion while holding handle 108 in front of his or her body and standing on top portion 104. In one example, motor 110 may supply constant resistance (e.g., 100 lbs. of resistance) during both the eccentric (descending) and concentric (ascending) phases of the squat. In another example, motor 110 may supply a first resistance (e.g., 50 lbs. of resistance) during the eccentric phase of the squat but subsequently increase resistance (e.g., to 100 lbs.) during the concentric phase of the squat, thereby emphasizing the concentric phase. In yet another example, motor 110 may supply relatively low resistance when the user is at depth but supply increased resistance as the user reaches an upright position. Among other things, such varying of resistance may encourage a full and safe range of motion by reducing load in typically problematic points of the exercise. As a final and additional non-limiting example, motor 110 may supply a random or otherwise dynamically varying resistance (e.g., a “noisy” load that ranges from 40 lbs. to 60 lbs.) over some or all of the squat motion, thereby forcing the user to recruit a broader range of stabilizing muscles than if a constant resistance were to be applied by motor 110.

As illustrated in FIG. 1, exercise platform 100 may include various other features. For example, housing 102 may include a grip 124 or similar feature to facilitate transportation of exercise platform 100. Exercise platform 100 may also include an electronics panel 126. Among other things, electronics panel 126 may include one or more ports to facilitate communication between exercise platform 100 and other computing devices, a display (e.g., an LED or LCD screen) for providing information to a user, one or more lights to indicate status or operation of exercise platform 100 (e.g., an “ON/OFF” light indicator), one or more switches (e.g., a power switch), and the like. In at least certain implementations, exercise platform 100 may include a battery such that exercise platform 100 may be optionally operated without being plugged into a wall outlet or other external power source. In such cases, exercise platform 100 may further include a charging port or similar plug (not illustrated) to facilitate charging of the battery or otherwise powering exercise platform 100.

Referring to FIG. 2, an isometric view of exercise platform 100 is provided with portions of housing 102 removed for clarity and to reveal internal components of exercise platform 100. As previously discussed, exercise platform 100 includes motor 110, which may be coupled to and drive a cable pulley 112 to control retraction and extension of cable 106. Exercise platform 100 includes an internal frame 114 that provides structural integrity to exercise platform 100 and structure for coupling to and supporting internal components of exercise platform 100. As illustrated, internal frame 114 includes a web 116 extending transversely through housing 102. In at least certain implementations, motor 110 is coupled to and supported by web 116 such that cable pulley 112 aligns with aperture 120 of top portion 104. Internal frame 114 may include additional elements to provide additional structural integrity and/or mounting locations for other components of exercise platform 100. For example, internal frame 114 may include one or more transverse members (such as transverse member 118), which extends parallel to but offset from web 116.

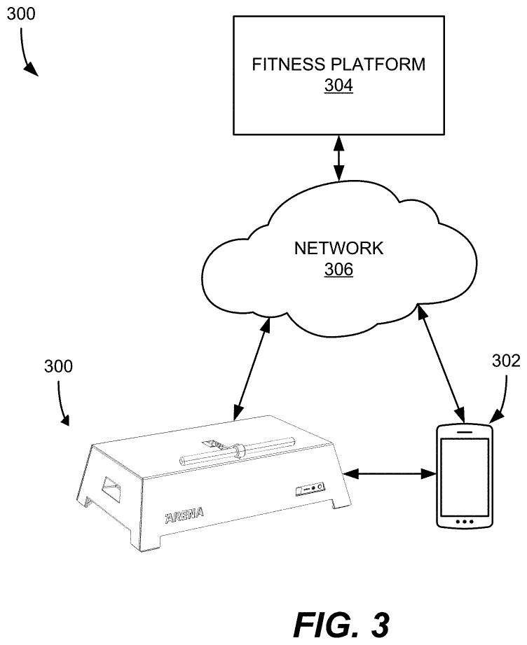

FIG. 3 illustrates an example operating environment 300 including exercise platform 100. In at least certain implementations, exercise platform 100 communicates with one or more external computing devices, such as computing device 302. Although illustrated as a smartphone, computing device 302 may be any suitable computing device capable of connecting to and communicating with a communication module or similar communication component of exercise platform 100 through a wired or wireless connection.

Computing device 302 may execute an application for interfacing with and controlling exercise platform 100. For example, the application executed on computing device 302 may permit a user of computing device 302 to change a resistance of exercise platform 100 or a resistance profile executed by exercise platform 100. In other implementations, the application may allow the user to select an exercise or workout routine the automatically reconfigures exercise platform 100 as the user progresses through the exercise or workout routine. During operation, exercise platform 100 may transmit data, such as position data for cable 106, such that the application may track successful completion of exercises and workout routines by the user.

One or both of exercise platform 100 and computing device 302 may further communicate with a fitness platform 304 over a network 306, such as the Internet. Among other things, fitness platform 304 may provide a portal, website, application, etc. through which a user of computing device 302 may access information and content related to use of exercise platform 100. For example, fitness platform 304 may include a repository or similar source of video, text, or other content directed to use of exercise platform 100, performing certain exercises, and/or fitness and exercise more generally. As another example, fitness platform 304 may support user accounts such that a user of computing device 302 and exercise platform 100 may track his or her historic performance and improvement, create and track workouts and fitness plans, participate in leaderboards and other community-related features, and the like. In at least certain implementations, fitness platform 304 may facilitate real-time classes, competitions, and similar group activities that simultaneously support multiple users of exercise devices. For example, in the context of a class, a live streamed video of an instructor may be provided by fitness platform 304 to multiple users and each exercise device (or a related/connected computing device) may in turn provide exercise data (e.g., resistance level, speed, rep completion, etc.) for maintaining and populating a class leaderboard or similar display of participant performance.

As noted above, implementations of exercise devices according to this disclosure rely on an electric motor to supply resistance during exercises performed by a user. Although electric motors can be cost effective, energy efficient, and highly controllable, many types of electric motors and motor-driven systems can be susceptible to vibration. From a device life perspective, excessive vibration can result in increased wear of components and loosening of fasteners, joints, etc., among other things. Vibration can also be a substantial source of noise during operation of a motor-driven device and, as a result, can have a significant impact on the usability and user experience of a device.

In the context of motor-driven exercise equipment, vibration and resulting noise can affect the user's enjoyment of and engagement with the equipment and can also dictate when and where a user may exercise with the equipment. For example, excessive vibration or noise may preclude use of the equipment due to concerns and complaints from neighbors or others living with the user. Even if not fully precluded, noise may nevertheless limit a user from exercising early in the morning or later in the evening when noise may be disruptive to others that live with the user. As another example, excessive noise may preclude use of certain equipment in a group or class setting where the din resulting from multiple pieces of equipment operating simultaneously may drown out an instructor or rise to the level of causing discomfort or hearing damage to class participants.

At least some vibration may result from mechanical considerations (e.g., motor imbalances, misalignment of components, etc.). Other sources of vibration may be the result of the specific type of motor and/or commutation method used. For example, brushless direct current (BLDC) motors are a cost-effective and easily controlled option for many electric motor applications and may be controlled using trapezoidal commutation (which is also referred to as “six-step commutation”). However, trapezoidal commutation is inherently noisy due to torque and cogging ripple. Such noise can be particularly noticeable and problematic at slower rotational speeds. Although tuning of the motor and commutation scheme may be used to reduce at least some vibration and noise, such tuning may be insufficient to reduce noise to a desirable level.

Considering the foregoing, the present disclosure includes structural improvements to motor-driven exercise devices for reducing vibration and corresponding noise. In one aspect of this disclosure, a specially designed dampening block supports the motor of the exercise device from an internal web of the exercise device. Specifically, the dampening block couples to a shaft of the motor to prevent rotation of the motor and has a layered construction including multiple dampening pads for attenuating vibration of the motor during operation. The dampening block further couples to an internal web of the exercise device such that the motor is cantilevered from the dampening block. In certain implementations, a reinforcing bracket extending from the dampening block to an internal frame of the exercise device supplies further support and dampening of motor vibrations.

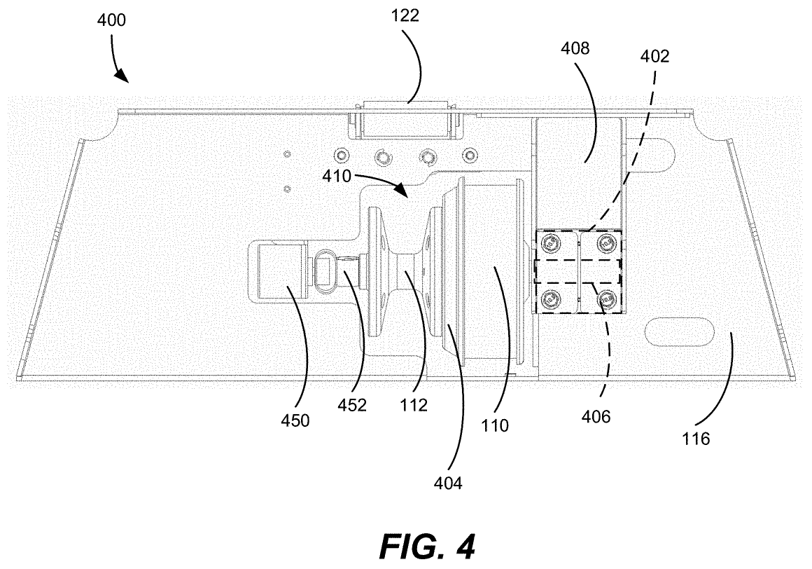

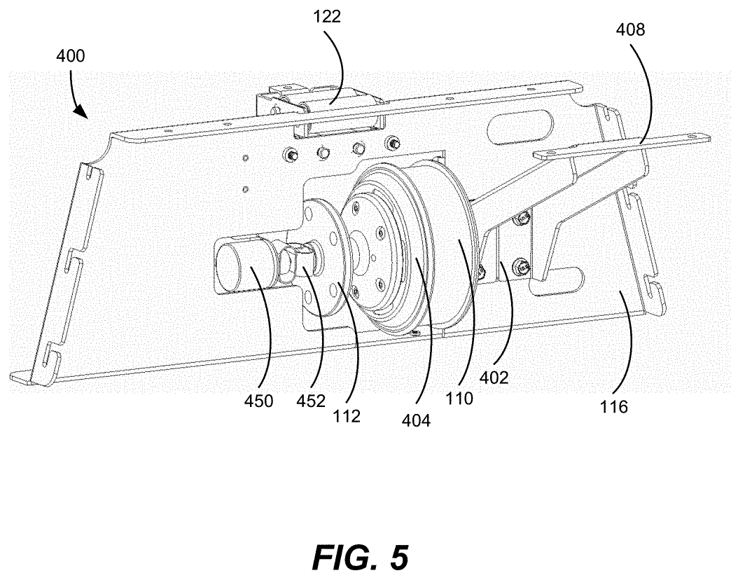

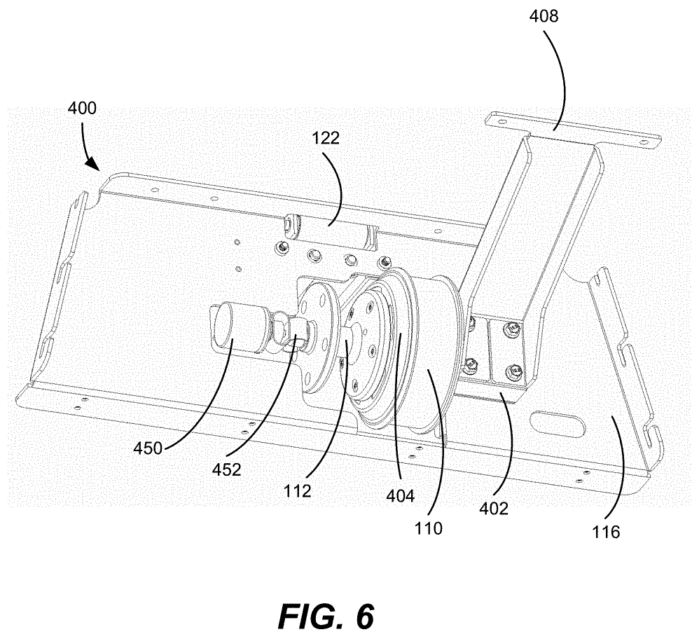

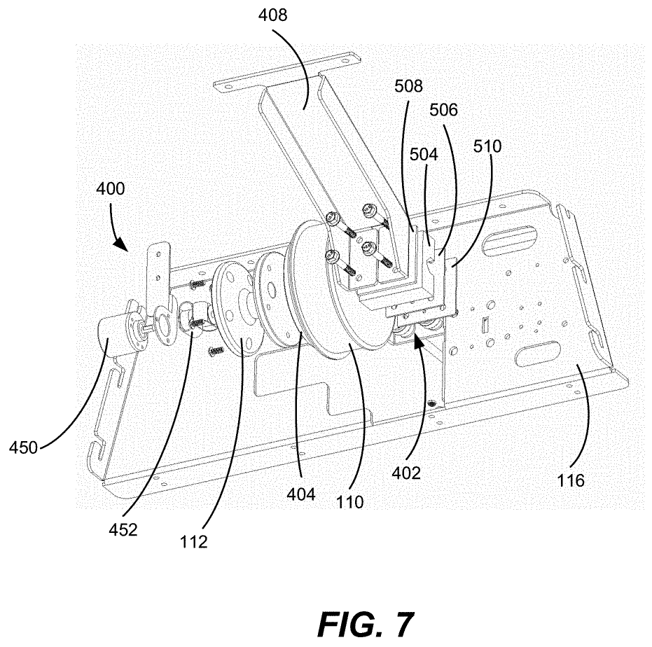

FIGS. 4-7 depict various views of web 116 and components coupled thereto. For convenience, this disclosure collectively refers to the components illustrated in FIGS. 4-7 as a web assembly 400. Accordingly, FIG. 4 is an elevation view of web assembly 400, FIG. 5 is a side perspective view of web assembly 400, FIG. 6 is a lower side perspective view of web assembly 400, and FIG. 7 is a lower exploded view of web assembly 400.

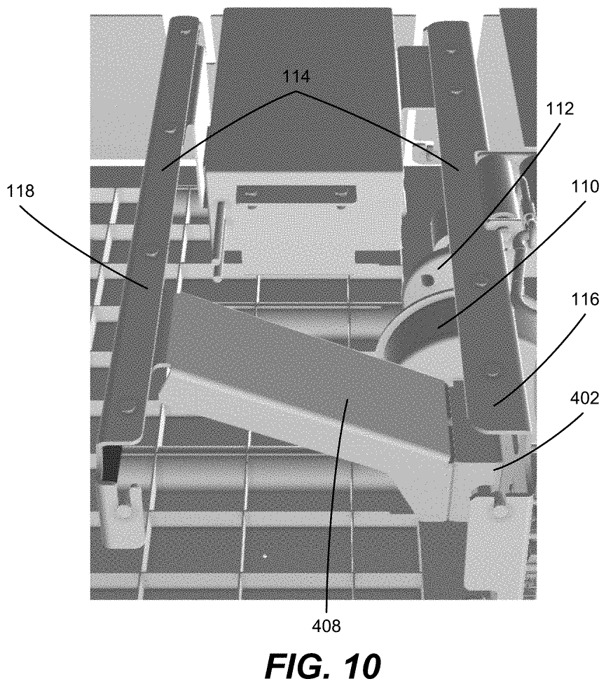

Referring to FIGS. 4-7, web assembly 400 includes web 116, which supports motor 110 within housing 102 (shown in FIG. 1). Web assembly 400 further includes a dampening block 402 that couples motor 110 to web 116 and a bracket 408 coupled to dampening block 402 and extending to transverse member 118 of internal frame 114 (e.g., as shown in FIG. 10).

In certain implementations, motor 110 is a brushless direct current (BLDC) hub motor. In general, a hub motor includes an internal motor assembly (not shown) about which a motor casing 404 rotates. Hub motors can be direct drive or geared. In direct drive hub motors, internal components of the hub motor function as the stator of the motor while the motor casing 404 is configured as the rotor. In contrast, the internal motor assembly of geared hub motors include both a stator and rotor. The rotor of the motor assembly mates with motor casing 404 by an internal gear assembly (e.g., a planetary gear assembly, not shown) such that rotation of the rotor indirectly drives rotation of motor casing 404 using the gears. In either design, the motor includes an externally protruding shaft for mounting the motor to a support structure and that couples to the stator (directly or indirectly). In most applications, mounting rotationally fixes the shaft such that the stator remains stationary during operation of the motor.

Web assembly 400 includes web 116 and motor 110 and related structures for coupling motor 110 to web 116. As illustrated, motor casing 404 of motor 110 may be coupled to cable pulley 112 such that rotation of motor casing 404 rotates cable pulley 112. Cable pulley 112 is further illustrated as being coupled to an encoder 450 configured to measure rotational position of cable pulley 112 and motor casing 404 during operation of exercise platform 100. Web 116 may further support fairing 122 in alignment with cable pulley 112 to guide a cable (not shown) spooled about cable pulley 112 outside of housing 102.

Dampening block 402 couples motor 110 to web 116. More specifically, dampening block 402 couples to web 116 and receives and rotationally fixes a shaft 406 of motor 110. As a result, motor 110 is cantilevered from dampening block 402 within housing 102 of exercise platform 100. To accommodate motor 110, cable pulley 112, encoder 450, and other internal components of exercise platform 100, web 116 may include one or more cutouts such as cutout 410 (shown in FIG. 4) within which those components may be at least partially disposed.

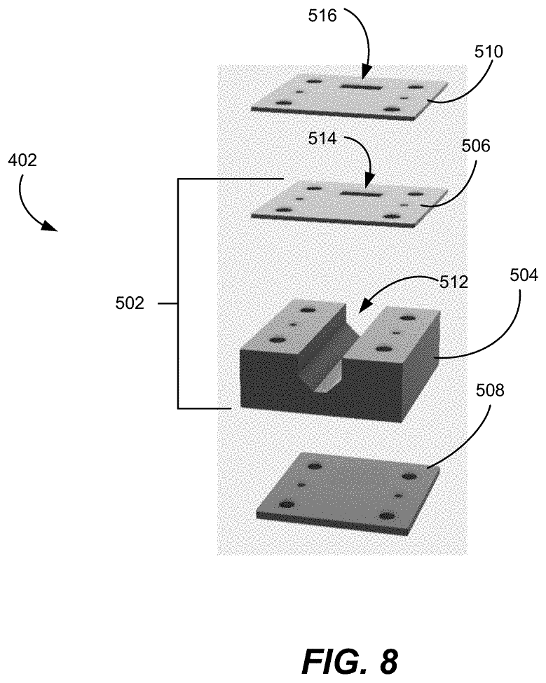

FIG. 8 is an exploded view of dampening block 402. In at least certain implementations, dampening block 402 may include a shaft coupling assembly 502 including a primary block 504 and a cover plate 506. Each of primary block 504 and cover plate 506 may be formed of a relatively rigid and solid material such as, without limitation, steel or aluminum. Dampening block 402 may further include various dampening pads. For example, as shown in FIG. 8, dampening block 402 includes a dampening pad 508 such that when dampening block 402 is assembled into web assembly 400, dampening pad 508 is positioned between primary block 504 and bracket 408. Dampening block 402 may further include a dampening pad 510 such that when dampening block 402 is assembled into web assembly 400, dampening pad 510 is positioned between cover plate 506 and web 116. In contrast to primary block 504 and cover plate 506, dampening pad 508 and dampening pad 510 may be formed from a suitable elastomeric material selected to absorb and dampen vibrations transmitted to shaft coupling assembly 502 by shaft 406. In certain implementations, one or both of dampening pad 508 and dampening pad 510 may have a layered construction of multiple materials or instead be replaced by multiple and separate dampening pads. In implementations in which bracket 408 is omitted, dampening pad 508 may be omitted from dampening block 402.

Primary block 504 may include a channel 512 that receives shaft 406 of motor 110 during assembly of web assembly 400. Cover plate 506 may also include a slot 514 or similar feature configured to fix rotation of shaft 406. In certain implementations and depending on the dimensions of shaft 406 and cover plate 506, dampening pad 510 may also include a slot 516 into which a portion of shaft 406 extends to rotationally fix shaft 406.

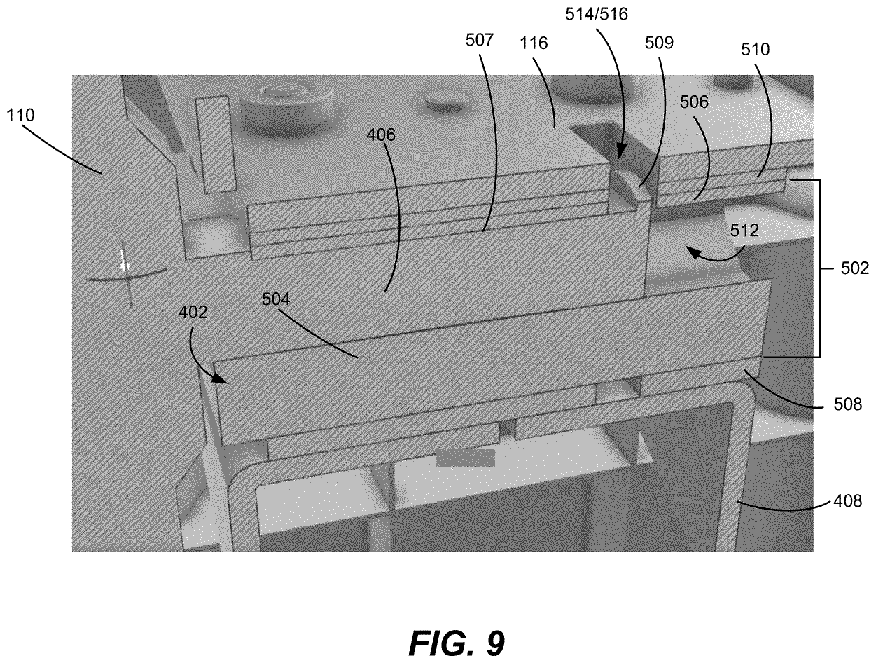

Coupling and fixation of shaft 406 by dampening block 402 is further illustrated in FIG. 9, which is a partial cross-sectional view of web assembly 400. FIG. 9 includes motor 110 from which shaft 406 extends. As shown, shaft 406 extends into dampening block 402 such that dampening block 402 supports shaft 406. Specifically, shaft 406 extends through channel 512 of primary block 504.

Although shaft 406 may be coupled to and retained by dampening block 402 in various ways, in at least certain implementations, shaft 406 may include a flat 507 such that a portion 509 distal flat 507 protrudes radially. In such implementations, when shaft 406 and dampening block 402 are assembled together, flat 507 may be positioned to abut cover plate 506 such that portion 509 extends into slot 514 and slot 516. In such a configuration, each of flat 507, slot 514, and slot 516 collectively provide both longitudinal and rotational constraints for shaft 406, thereby coupling motor 110 to dampening block 402 and web 116.

As previously noted, bracket 408 may provide additional support and dampening of motor 110. As shown in FIGS. 4-7, bracket 408 is coupled to dampening block 402 and extends from dampening block 402. Referring to FIG. 10, in at least certain implementations bracket 408 may extend from dampening block 402 to transverse member 118 of internal frame 114. As illustrated in both FIGS. 2 and 10, transverse member 118 may extend through housing 102 parallel to web 116 and below top portion 104. In at least certain implementations, a dampening pad or similar insert (not shown) may be disposed between bracket 408 and transverse member 118 to provide additional dampening and noise reduction.

Although FIG. 10 illustrates bracket 408 extending to transverse member 118, this disclosure contemplates that bracket 408 may extend to any substantially fixed element of exercise platform 100 and, in particular, other elements of internal frame 114. So, for example, while FIGS. 2 and 10 illustrate bracket 408 as extending in an upwardly slanted direction to couple with transverse member 118 below top portion 104, bracket 408 may alternatively extend in a downwardly slanted direction to couple bracket 408 to a similar member or structural element disposed adjacent a bottom portion of housing 102. More generally, bracket 408 may be configured to extend between dampening block 402 and any suitable fixed location or structure within housing 102.

During operation of motor 110, shaft 406 transmits resulting vibrations of motor 110 to dampening block 402, which in turn transmits the vibrations to internal frame 114. More specifically, dampening block 402 transmits at least a portion of the vibrational energy to web 116 due to the coupling of dampening block 402 to web 116. Notably, dampening pad 510 (disposed between shaft coupling assembly 502 of dampening block 402 and web 116) dampens at least a portion of the vibrational energy transmitted from dampening block 402 to web 116. In implementations including bracket 408, an additional portion of the vibrational energy is transmitted from dampening block 402 to transverse member 118 (or a similar component of internal frame 114) due to the coupling of bracket 408 to both dampening block 402 and transverse member 118. Dampening pad 508 (disposed between shaft coupling assembly 502 and bracket 408) dampens at least a portion of the vibrational energy transmitted from dampening block 402 to bracket 408.

In addition to dampening pad 508 and dampening pad 510, additional dampening and acoustic cancelation may be provided by various structural elements of exercise platform 100. For example, and without limitation, one or more of web 116, bracket 408, and transverse member 118 (or other structural member to which bracket 408 couples) may be made of materials or be shaped to dampen vibrations or shift vibration frequencies. Moreover, additional dampening pads or similar dampening components may be disposed between components of exercise platform 100 (e.g., between elements of internal frame 114) or between exercise platform 100 and the surrounding environment (e.g., on the underside of housing 102 such that the dampening pads are between exercise platform 100 and the floor) to further dampen vibrations resulting from operation of motor 110.

Each of dampening block 402 and bracket 408 provide substantial dampening of vibration generated by motor 110 during use of exercise platform 100 and a corresponding reduction in noise. Among other things, the reduction enables the use of cost-effective albeit noisier motor types and control schemes. For example, and as noted above, BLDC motors operated using trapezoidal commutation are often considered efficient and cost-effective but ultimately noisy, particularly when operated at low speeds. During testing and development, the dampening techniques and structures disclosed herein substantially reduced vibration such that BLDC motors using trapezoidal commutation were found to be a suitable alternative to more costly but inherently quieter motor configurations.

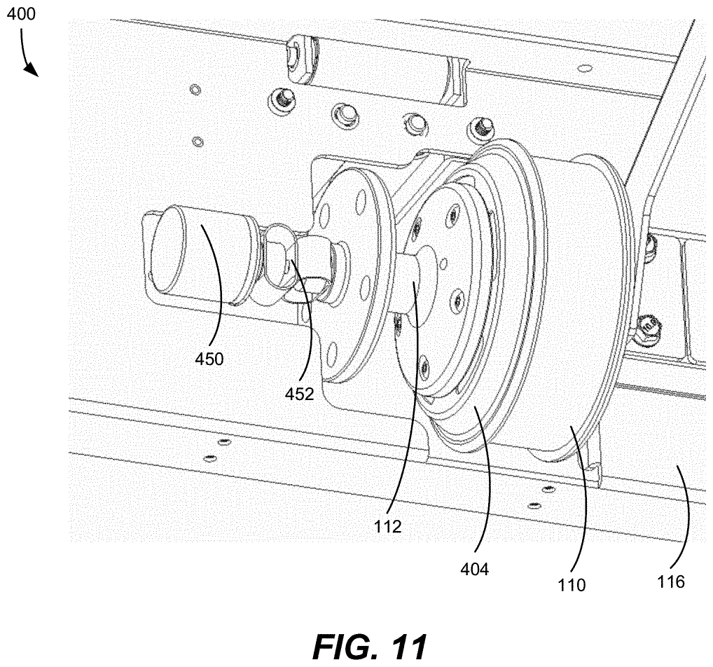

As noted in the context of FIGS. 4-7, web assembly 400 may further include encoder 450 for measuring rotation of cable pulley 112 and motor 110. FIG. 11 is a view of the web assembly of FIG. 4 illustrating an example arrangement of an encoder and encoder coupling. In at least certain implementations and as illustrated in FIG. 11, encoder 450 may be coupled to web 116 using a suitable bracket or support such that a shaft of encoder 450 is aligned with cable pulley 112 and motor 110. To permit at least some misalignment between encoder 450 and cable pulley 112/motor 110, web assembly 400 may include a flexible coupling 452 for coupling the shaft of encoder 450 to cable pulley 112. For example, flexible coupling 452 may be a double-loop style encoder coupling. Notably, due to flexible coupling 452, encoder 450 does not provide any substantial load bearing support for motor 110 such that motor 110 remains substantially supported at dampening block 402.

Although various representative embodiments have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member, or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An exercise device comprising:
a housing including a top portion and a bottom portion;
an internal frame disposed within the housing, wherein the internal frame includes a web extending between the top portion and the bottom portion;
a dampening block coupled to the web;
a motor including a motor casing and a shaft, wherein the shaft is supported by the dampening block and rotationally fixed by the dampening block; and
a cable pulley coupled to the motor casing such that, when the motor is actuated, each of the motor casing and the cable pulley rotate.

2. The exercise device of claim 1, wherein the dampening block comprises:
a shaft coupling assembly, wherein the shaft extends into the shaft coupling assembly and is rotationally fixed by the shaft coupling assembly; and
a dampening pad disposed between the shaft coupling assembly and the web.

3. The exercise device of claim 1, wherein the dampening block comprises:
a shaft coupling assembly including:
a block defining a channel, wherein the shaft extends along the channel; and
a cover plate abutting the block and covering the channel, wherein the shaft includes a flat within which a portion of the cover plate is disposed to rotationally fix the shaft; and
a dampening pad disposed between the shaft coupling assembly and the web.

4. The exercise device of claim 1 further comprising a bracket coupled to each of the dampening block and the internal frame, wherein the dampening block includes a shaft coupling assembly and a dampening pad disposed between the bracket and the shaft coupling assembly.

5. The exercise device of claim 1 further comprising a bracket, wherein the internal frame further includes a transverse member offset from the web, and wherein the bracket is coupled to each of the dampening block and the transverse member.

6. The exercise device of claim 1, further comprising a bracket, wherein the internal frame further includes a transverse member offset from the web and disposed adjacent the top portion, and wherein the bracket is coupled to each of the dampening block and the transverse member.

7. The exercise device of claim 1 further comprising an encoder supported by the web, wherein the cable pulley is coupled to the encoder by a flexible shaft coupling and the encoder is configured to measure rotation of the cable pulley.

8. The exercise device of claim 1, wherein the motor is a brushless direct current (BLDC) motor and the exercise device further includes a motor controller to actuate the motor using trapezoidal commutation.

9. The exercise device of claim 1, wherein the web is coupled to each of the top portion and the bottom portion.

10. An exercise device comprising:
a housing;
a motor including a motor casing and a shaft, wherein the shaft is rotationally fixed within the housing by a dampened connection and supports the motor casing within the housing; and
a cable pulley extending from the motor casing such that, when the motor is actuated, each of the motor casing and the cable pulley rotate.

11. The exercise device of claim 10, further comprising an internal frame disposed within the housing, wherein the dampened connection includes a dampening block coupled to the internal frame.

12. The exercise device of claim 10, further comprising an internal frame disposed within the housing, wherein the internal frame includes a web extending between a top portion of the housing and a bottom portion of the housing, and wherein the dampened connection includes a dampening block coupled to the web.

13. The exercise device of claim 10, further comprising an internal frame disposed within the housing, wherein the dampened connection includes:
a dampening block coupled to the internal frame; and
a bracket coupled to and extending between each of the dampening block and the internal frame.

14. The exercise device of claim 10, further comprising an internal frame disposed within the housing, wherein the dampened connection includes:
a dampening block coupled to a transverse web of the internal frame; and
a bracket coupled to and extending between each of the dampening block and a transverse member of the internal frame offset from the transverse web.

15. The exercise device of claim 10, further comprising:
an internal frame disposed within the housing, wherein the internal frame includes a web extending between a top portion and a bottom portion of the housing, and wherein the dampened connection is between the shaft and the web; and
an encoder supported by the web and rotationally coupled to the cable pulley to measure rotation of the cable pulley.

16. The exercise device of claim 10, wherein the motor is a brushless direct current (BLDC) motor and the exercise device further comprises a controller to actuate the motor using trapezoidal commutation.

17. An exercise device comprising:
a housing including a top portion and a bottom portion;
an internal frame disposed within the housing, wherein the internal frame includes a web extending between the top portion and the bottom portion and a support member offset from the web;
a dampening block coupled to the web;
a bracket coupled to and extending between each of the dampening block and the support member; and
a motor including a motor casing and a shaft, wherein the shaft is rotationally fixed by the dampening block.

18. The exercise device of claim 17, wherein the motor is a brushless direct current (BLDC) motor and the exercise device further comprises a motor controller to actuate the motor using trapezoidal commutation.

19. The exercise device of claim 17, wherein the dampening block includes:
a block defining a channel, the shaft extending through the channel;
a cover plate abutting the block, wherein the cover plate rotationally fixes the shaft;
a first dampening pad disposed between and abutting each of the cover plate and the web; and
a second dampening pad disposed between and abutting each of the cover plate and the bracket.

20. The exercise device of claim 17, wherein the top portion includes an aperture, the exercise device further comprising:
a cable pulley coupled to the motor casing;
a cable coupled to the cable pulley; and
a fairing disposed in the aperture, wherein the cable is routed through the aperture and selectively retractable through the aperture by actuating the motor.
